(19) United States
(12) Patent Application Publication
(10) Pub. No.: US 2010/0106353 A1
(43) Pub. Date: Apr. 29, 2010

(54) REGENERATIVE BRAKING AND CHARGE FLOW STATE INDICATION SYSTEM FOR A HYBRID ELECTRIC VEHICLE

(75) Inventors: Angela L. Watson, Ann Arbor, MI (US); David Watson, Ann Arbor, MI (US); Jeffrey Greenberg, Ann Arbor, MI (US); Ryan J. Skaff, Farmington Hills, MI (US); Michael Blommer, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/259,478

(22) Filed: Oct. 28, 2008

(51) Int. Cl. B60W 20/00

(52) U.S. Cl. 701/22; 903/903

(57) ABSTRACT

A system and method for using an information display to display information relating to a state of charge of the battery, a charge flow state of the battery, and a regenerative and friction braking system. The information display displaying the state of charge information that corresponds to the available energy capacity of the battery as a percentage of the total rated capacity of the battery. The information display displaying the charge flow state information that corresponds to a negative and positive charge flow state of the battery. The information display also displaying when the vehicle is operating the regenerative braking system or when the vehicle is operating the regenerative braking system and the friction braking system.

### BACKGROUND

1. Technical Field

One or more embodiments of the present application relate to a system and method for displaying regenerative braking and charge flow state information.

2. Background Art

Vehicles, whether passenger or commercial, include a number of gauges, indicators, and various other displays to provide the vehicle driver with information regarding the vehicle and its surroundings. With the advent of new technologies, such as hybrid electric vehicles (HEVs), has come a variety of new gauges and information displays that help drivers to better learn the operation of these vehicles that utilize new technology. For example, many HEVs incorporate gauges that attempt to provide the driver with information on the various hybrid driving states. These gauges indicate to the driver when the vehicle is being propelled by the engine alone, the motor alone, or a combination of the two. Similarly, a display may indicate when the motor is operating as a generator, and is recharging an energy storage device, such as a battery.

With regard to HEVs, it is known that some drivers may not understand or appreciate the fact that a battery has a limited useable range. The percentage of charge available within this usable range is typically defined as the state of charge (SOC) of the battery. Furthermore, the driver may not understand or appreciate when or from where the battery is being charged or discharged.

Therefore, a need exists for an information display for a vehicle, and a method for displaying such information, that indicates to a driver the useable state of charge of the battery and when and from where the battery is being charged or discharged.

### BRIEF DESCRIPTION OF THE DRAWINGS

FIG. 1 shows a schematic representation of a hybrid electric vehicle including an information display in accordance with one or more embodiments of the present application;

FIG. 2a shows in detail the information display depicted in FIG. 1;

FIG. 2b shows an alternate view of the information display depicted in FIG. 2a;

FIG. 2c shows another alternate view of the information display depicted in FIG. 2a;

FIG. 2d shows yet another alternate view of the information display depicted in FIG. 2a; and

FIG. 3 is a simplified, exemplary flow chart depicting at least one embodiment of the present application described herein.

### DETAILED DESCRIPTION

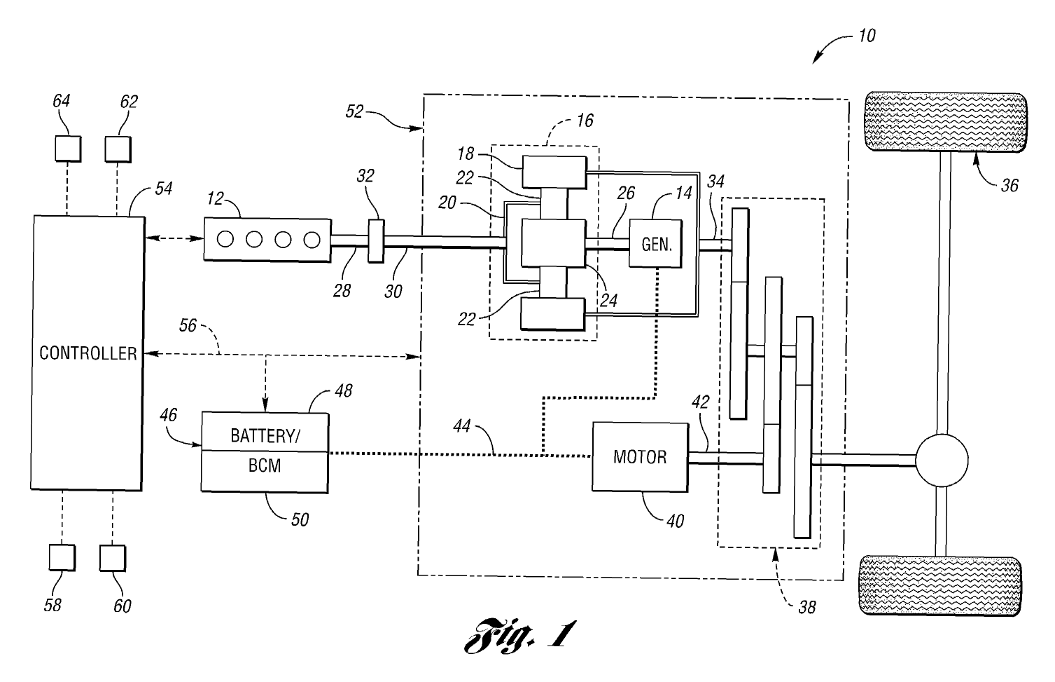

FIG. 1 shows a schematic representation of a vehicle 10, which includes an engine 12 and an electric machine, or a generator 14. The engine 12 and the generator 14 are connected through a power transfer arrangement, which in this embodiment, is a planetary gear arrangement 16. Of course, other types of power transfer arrangements, including other gear sets and transmissions, may be used to connect the engine 12 to the generator 14. The planetary gear arrangement 16 includes a ring gear 18, a carrier 20, planet gears 22, and a sun gear 24.

The generator 14 can also output torque to a shaft 26 connected to the sun gear 24. Similarly, the engine 12 outputs torque to a crankshaft 28, which is connected to a shaft 30 through a passive clutch 32. The clutch 32 provides protection against over-torque conditions. The shaft 30 is connected to the carrier 20 of the planetary gear arrangement 16, and the ring gear 18 is connected to a shaft 34, which is connected to a first set of vehicle drive wheels, or primary drive wheels 36, through a gear set 38.

The vehicle 10 includes a second electric machine, or motor 40, which can be used to output torque to a shaft 42 connected to the gear set 38. Other vehicles within the scope of the one or more embodiments of the present application may have different electric machine arrangements, such as more or fewer than two electric machines. In the embodiment shown in FIG. 1, the electric machine arrangement (i.e. the motor 40 and the generator 14) can both be used as motors to output torque. Alternatively, each can also be used as a generator, outputting electrical power to a high voltage bus 44 and to an energy storage system 46, which includes a battery 48 and a battery control module (BCM) 50.

The battery 48 is a high voltage battery that is capable of outputting electrical power to operate the motor 40 and the generator 14. The BCM 50 acts as a controller for the battery 48. Other types of energy storage systems can be used with a vehicle, such as the vehicle 10. For example, a device such as a capacitor can be used, which, like a high voltage battery, is capable of both storing and outputting electrical energy. Alternatively, a device such as a fuel cell may be used in conjunction with a battery and/or capacitor to provide electrical power for the vehicle 10.

As shown in FIG. 1, the motor 40, the generator 14, the planetary gear arrangement 16, and a portion of the second gear set 38 may generally be referred to as a transmission 52. To control the engine 12 and components of the transmission 52 (i.e., the generator 14 and motor 40) a vehicle control system, shown generally as controller 54, is provided. Although it is shown as a single controller, it may include multiple controllers which may be used to control multiple vehicle systems. For example, the controller 54 may be a vehicle system controller/powertrain control module (VSC/PCM). Furthermore, one or more embodiments of the present application contemplate that the BCM 50 may be included within the controller 50 and may not be a separate controller, as shown in FIG. 1.

A controller area network (CAN) 56 allows the controller to communicate with the transmission 52 and the BCM 50. Just as the battery 48 includes a BCM 50, other devices may have their own controllers. For example, an engine control unit (ECU) may communicate with the controller 54 and may perform control functions on the engine 12. In addition, the transmission 52 may include a transmission control module (TCM), configured to coordinate control of specific components within the transmission 52, such as the generator 14 and/or the motor 40. Some or all of these various controllers can make up a control system in accordance with the present application. Although illustrated and described in the context of the vehicle 10, which is an HEV, it is understood that embodiments of the present application may be implemented on other types of vehicles, such as those powered by an engine or electronic motor alone.

Also shown in FIG. 1 are simplified schematic representations of a braking system 58, an accelerator pedal 60, and an air conditioning system 62. The braking system 58 may include such things as a brake pedal, position sensors, pressure sensors, or some combination of the two. The braking system 58 may also include a friction braking system that comprises a mechanical connection to the vehicle wheels, such as the wheels 36, so as to effect friction braking. The braking system 58 may also include a regenerative braking system, wherein braking energy is regained, or captured, and stored as electrical energy in the battery 48. Similarly, the accelerator pedal 60 may include one or more sensors, which, like the sensors in the braking system 58, communicate with the controller 54.

The air conditioning system 62 also communicates with the controller 54. The on/off status of the air conditioning system can be communicated to the controller 54, and can be based on, for example, the status of an driver actuated switch, or the automatic control of the air conditioning system 62 based on related functions such as window defrost. In addition to the foregoing, the vehicle 10 may include an information display system 64, which, as explained in detail below, can provide a state of charge (SOC), charge mode, charge of the battery 48, or the like, to the driver of the vehicle 10.

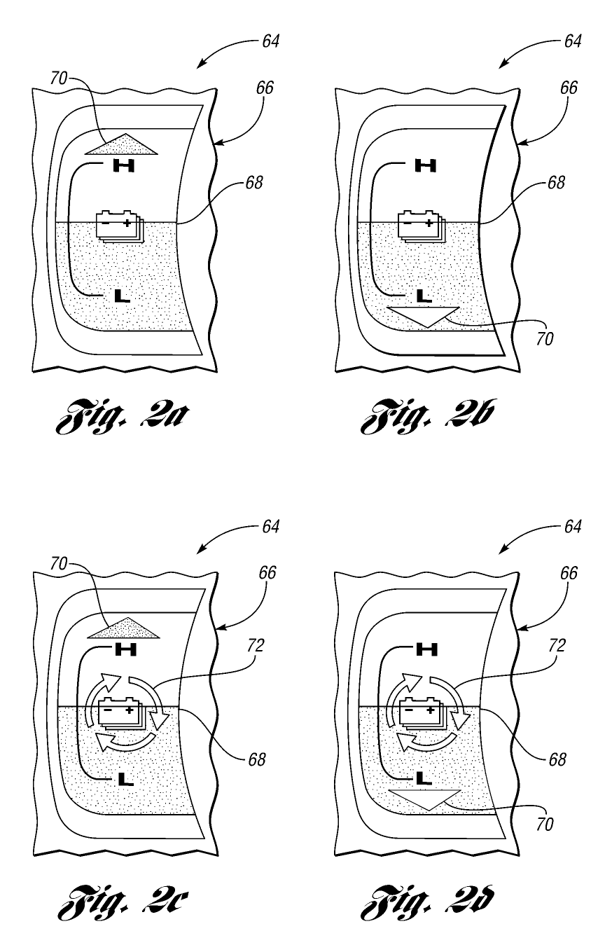

FIGS. 2a-2d illustrate an exemplary embodiment of the information display system 64. The information display system 64 may include an information display 66 and electronics, including software, which are not shown in FIGS. 2a-2d. The information display 66 may also indicate to a driver the SOC of the battery 48, the charge flow of the battery 48, and regenerative braking information using any number of analog gauges. Alternatively, the information display 66 may indicate the SOC of the battery 48, the charge flow of the battery 48, and regenerative braking information using a liquid crystal display (LCD), a plasma display, an organic light emitting display (OLED) or any other display suitable to display state of energy information.

The SOC of the battery 48 may be displayed to the driver by determining the ratio of energy currently stored in the battery 48 with reference to the battery's maximum energy capacity. Stated differently, the information display 66 may indicate the SOC to the driver by displaying the available energy capacity of the battery 48 as a percentage of the total rated capacity of the battery 48.

Rather than demarcating when the battery 48 is full or empty, the information display 66 may identify a useable energy range of the battery 48. In order to ensure that the SOC of the battery 48 remains within the useable energy range, the BCM 50, or the controller 54, may monitor the battery 48 to determine if the battery 48 may be encountering an over-voltage (overcharged) condition or an under-voltage (undercharged) condition. As such, the BCM 50, or the controller 54, may operate to control the flow of energy into or out of the battery 48 so that an undercharged or overcharged condition does not occur.

With reference back to the illustrations, FIGS. 2a and 2b illustrate two non-limiting embodiments of the information display 66. FIG. 2a illustrates the information display 66 and a SOC indicator 68. The SOC indicator 68 may be depicted as a “bubble” level meter. However, one or more embodiments of the present application also recognize that the SOC indicator 68 could be depicted as an indicator line, a bar graph, or any other display indicator that may graphically represent to the driver the SOC of the battery 48 of the vehicle 10.

One or more embodiments of the present application also contemplate that the controller 54 may receive information relating to the possible degradation of the battery 48 in response to continually being charged and discharged. The controller 54 may use the information in order to calculate a new SOC for the battery 48. In turn, the controller 54 may transmit the new SOC so that the information display 66 displays the new SOC via the SOC indicator 68. For example, after being charged and discharged multiple times, the battery 48 may only have an energy capacity of around 80% of its original rated energy capacity. As such, the controller 54 may determine and transmit a new SOC value of the battery 48 so that the information display 66 displays the newly determined SOC value. The driver may be informed as to the new relative SOC of the battery 48. By continually updating the SOC indicator 68, the driver may learn how to operate the vehicle in a manner that does not exhaust the useable range of the battery 48.

One or more embodiments of the present application further contemplate that the battery 48 may also operate in one of two separate charge flow states. The controller 54 may determine that the battery 48 is in a positive charge flow state if the energy being captured by the battery 48 (e.g., from the motor 40 or the generator 14) exceeds the energy being discharged to the motor 40, the generator 14, or various electrical accessories throughout the vehicle 10. Alternatively, the controller 54 may determine that the battery 48 is in a negative charge flow state if the energy being discharged to the motor 40, the generator 14, or various electrical accessories throughout the vehicle 10 by the battery 48 exceeds the energy being captured.

FIGS. 2a and 2b further illustrate exemplary embodiments of how the information display 66 may display both the positive and negative charge flow state to the driver using a charge flow state indicator 70. As shown in FIG. 2a, the charge flow state indicator 70 may be depicted as an “up” arrow which can indicate that the flow of current is such that the battery 48 is receiving a positive net charge. Therefore, FIG. 2a indicates to the driver that the vehicle is operating in the positive charge flow state.

With reference to FIG. 2b, the charge flow state indicator 70 may be depicted as a “down arrow” which can indicate that the flow of current is exiting the battery 48 such that the battery 48 is losing energy. As such, FIG. 2b indicates that the vehicle 10 is operating in the negative charge flow state.

Although the charge flow state indicator 70 is represented as an “up” or “down” arrow, one or more embodiments of the present application contemplate that other charge flow state indicators may be provided without departing from the scope of the present application. For example, the charge flow state indicator 70 may be displayed as a plus (+) symbol and a negative (−) symbol. As such, when the battery 48 operates in the positive charge flow state, the plus (+) symbol may be illustrated. Conversely, when the battery 48 operates in the negative charge flow state, the negative (−) symbol may be displayed.

With reference to FIGS. 2c and 2d, the information display 66 may also illustrate a regenerative braking indicator 72. FIGS. 2c and 2d illustrate the regenerative braking indicator 72 as a circular arrow configuration. One or more embodiments of the present application contemplate that the regenerative braking indicator 72 may also be illustrated in a fashion different than that illustrated in FIGS. 2c and 2d so long as the driver is visually or audibly informed that the regenerative brake system has been activated.

As stated above, the braking system 58 may provide friction braking using the friction braking system. Furthermore, the braking system 58 may provide regenerative braking using the regenerative braking system. The regenerative braking system may operate to regain, or capture, some of the energy lost when the vehicle 10 is slowing or stopping. The captured energy may be saved by the battery 48 and used later to power the vehicle 10. As is known to one skilled in the art, use of only friction braking may result in a certain percentage of the vehicle's generated power being dissipated as heat energy when slowing or stopping the vehicle 10. The percentage of energy lost by the friction braking may result in a lower efficiency because the percentage of energy lost during braking will need to be replaced by the vehicle 10 in order to regain forward propulsion. The energy regained by the regenerative braking systems may be used in order to provide torque that can be used to power the vehicle 10. Unfortunately, regenerative braking systems may not always be capable of slowing the vehicle 10 suddenly or bringing the vehicle 10 to an abrupt stop. Therefore, most vehicles, including the vehicle 10 of the present application, include a combination of friction braking and regenerative braking.

The controller 54 may control the braking system 58 so that the vehicle 10 may be slowed or stopped using a regenerative braking state that only uses the regenerative braking system. Furthermore, the controller 54 may control the braking system 58 so that the vehicle may be slowed or stopped using a regenerative and friction combination braking state (regenerative/friction braking state) that uses a combination of the regenerative and friction braking systems. The regenerative braking state may operate so as to allow the vehicle 10 to regain the greatest amount of energy using the regenerative braking system. The regenerative/friction braking state may operate so as to allow some energy to be regained while the friction braking operates to bring the vehicle 10 to a more abrupt stop. The controller 54 may determine whether to use the regenerative braking state or the regenerative/friction braking state based upon, for example, how much pressure is being applied to the brake pedal. For example, if the driver slightly depresses the brake pedal in order to decrease the speed of the vehicle, then the controller 54 may activate only the regenerative braking state. Conversely, if the driver applies a substantial pressure to the brake pedal, the controller 54 may activate the regenerative/friction braking state in order to bring the vehicle 10 to a more abrupt stop.

Information relating to when the controller 54 changes from the regenerative braking state to the regenerative braking/friction braking state may be used by the driver to increase the overall efficiency of the vehicle 10. For example, if the driver is informed that depressing the pedal with a certain force may activate the regenerative braking state, but depressing the pedal with a more substantial force may activate the regenerative/friction braking state, the driver may modify operation of the vehicle 10 so that more of the regenerative braking state is requested. As such, the overall efficiency of the vehicle may increase due to the driver modifying the operation of the vehicle so that a greater percentage of energy is recaptured using the regenerative braking state. For example, if the driver was informed, through the use of the regenerative braking indicator 72, what amount of braking force switched the vehicle 10 from the regenerative braking state to the regenerative/friction braking state, the driver may adjust the operation of the vehicle 10 to increase the amount of regenerative braking state requested. By increasing the regenerative braking state being used by the vehicle 10 the driver may increase the overall efficiency of the vehicle.

With reference back to FIGS. 2c and 2d, the regenerative braking indicator 72 may display when the vehicle 10 is being operated in the regenerative brake state. For example, the regenerative braking indicator 72 may illuminate, or otherwise appear, in a green color when the controller 54 activates the regenerative brake state. Moreover, the regenerative braking indicator 72 may illuminate, or otherwise appear, in a blue color when the controller 54 activates the regenerative/friction brake state. As such, the driver may be visually informed when the vehicle 10 is using the regenerative brake state as opposed to when the vehicle 10 is using the regenerative/friction brake state. The driver may use the visual indication in order to modify operation of the vehicle 10 in order to increase the amount of regenerative braking state used.

One or more embodiments of the present application contemplate that the colors used above are merely exemplary and that the regenerative braking indicator 72 may indicate to the drive the regenerative brake state and the regenerative/friction brake state using any combination of color or visual indicators. For example, when the controller 54 activates the regenerative braking state, the regenerative braking indicator 72 may display “Regenerative Braking Active.” Alternatively, when the controller activates the regenerative/friction braking state, the regenerative braking indicator 72 may display “Regenerative/Friction Braking Active.” As such, the driver may be visually informed as to when the controller switches from the regenerative braking state to the regenerative/friction braking state.

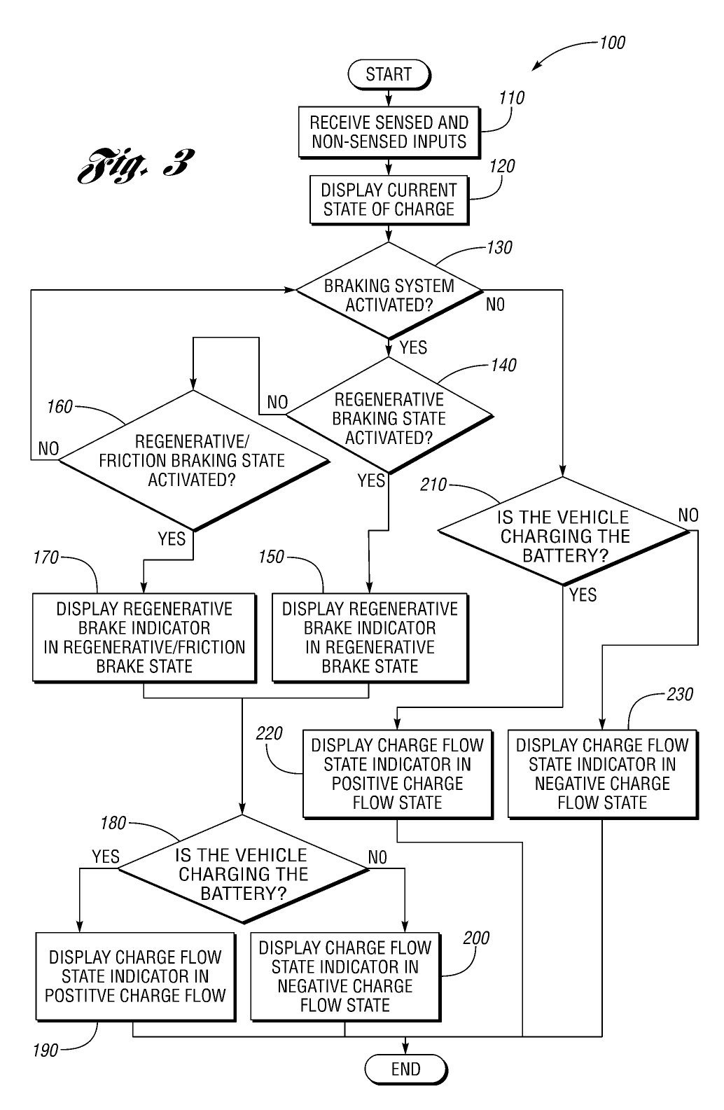

With reference back to the illustrations, FIG. 3 is a simplified, exemplary flow diagram 100 demonstrating how the controller 54 may determine, and the information display 66 displays, the current SOC, the current charge flow state and the current regenerative braking state. To begin, step 110 illustrates that the controller 54 may receive any number of sensed or non-sensed vehicle inputs that correspond to current operating conditions of the vehicle 10. More particularly, the controller 54 may receive sensed or non-sensed vehicle inputs that may relate to the SOC, the charge flow state, or the regenerative brake state. The received inputs may be used by the controller 54 in order to determine a current SOC of the battery 48, a current charge flow state of the battery 48, and the current brake state of the vehicle.

Once the sensed and non-sensed inputs are received by the controller 54 the flow diagram 100 may proceed to step 120. In step 120, the controller 54 may determine a current SOC value of the battery 48. As stated above, the controller 54 may determine the current available energy capacity of the battery 48 as a percentage of the total rated capacity of the battery. The controller 54 may transmit the current SOC value and the information display 66 may display the current SOC value using the SOC indicator 68. Once the SOC indicator 68 is modified so that the current SOC value is displayed upon the information display 66, the flow diagram 100 may then proceed to step 130.

In step 130, the controller 54 may determine if the braking system 58 is activated. If the braking system 58 is active, the flow diagram moves to step 140 where the controller 54 may determine if the regenerative braking state is activated. If the regenerative braking state is active, the flow diagram 100 may proceed to step 150. In step 150, the controller may transmit information that the vehicle is operating in the regenerative braking state and the information display 66 may display that the vehicle is operating in the regenerative braking state using the regenerative braking indicator 72. As stated above, the regenerative braking indicator 72 may be displayed in such a fashion so as to indicate to the driver that the vehicle is being operated in the regenerative braking state as opposed to the regenerative/friction braking state.

With reference back to step 140, if the controller 54 determines that the regenerative brake state has not been activated, then the flow diagram 100 may proceed to step 160. In step 160 the controller 54 may determine if the regenerative/friction braking state has been activated. If the regenerative/friction braking state has not been activated, then the flow diagram 100 may proceed back to step 130. If the regenerative/friction brake state has been activated, then the flow diagram 100 may proceed to step 170. In step 170, the controller may transmit information that the vehicle is operating in the regenerative/friction braking state and the information display 66 may display that the vehicle is operating in the regenerative/friction braking state using the regenerative braking indicator 72. Similar to step 150, the regenerative braking indicator 72 may be displayed in such a fashion so as to indicate to the driver that the vehicle is being operated in the regenerative/friction braking state as opposed to the regenerative braking state.

Once the regenerative braking indicator 72 indicates that the braking system 58 is operating in the regenerative braking state, as in step 150, or in the regenerative/friction braking state, as in step 170, the flow diagram 100 may proceed to step 180. In step 180, the controller 14 may determine if the vehicle 10 is in the positive charge flow state. If so, the flow diagram 100 may proceed to step 190. In step 190, the controller 54 may transmit the current charge flow state so that the information display may display a positive charge flow state using the charge flow state indicator 70. The charge flow state indicator 70 may be displayed in any fashion so as to indicate to the driver that more energy is being captured by the battery 48 then is being discharged. For example, the charge flow state indicator 70 shown in FIG. 2c may be displayed to the driver as a green or blue up arrow. The charge flow state indicator 70 may be displayed in a fashion that varies from the charge flow state indicator 70 displayed in FIG. 2a. As such, the information display 66 may convey to the driver when the vehicle 10 is charging the battery 48 using the regenerative braking system, as illustrated in FIG. 2c, as opposed to when the battery 48 is receiving charge from some other source, as illustrated in FIG. 2a.

With reference back to step 180, if the controller 54 determines that the vehicle 10 is in the negative charge flow state, then the flow diagram 100 may proceed to step 200. In step 200, the controller may transmit information that the vehicle is operating in the negative charge flow state and the information display 66 may display that the vehicle is operating in the negative charge flow state using the charge flow state indicator 70. As such, the driver may be informed that the regenerative braking system has been activated but the vehicle 10 is in the negative charge flow state.

The combination of the negative charge flow state and the regenerative braking indicator 72 illustrated in FIG. 2d may occur when the total power being demanded from the battery 48 is greater than the power being captured, or generated, from the regenerative braking system. For example, if the driver were to depress the acceleration pedal 60, mildly activate the braking system 58 so that the vehicle is using the regenerative braking system, and the driver has many accessories activated (e.g. radio, air conditioning system 62), then the total energy being consumed may be greater than the energy being generated. Another example may occur when the regenerative/friction braking state is activated and the air conditioning system 62 is operating at full capacity in an extremely warm environment (e.g., a very hot, humid summer day or within a desert environment). In either of the above examples, the controller 54 may determine that the amount of energy being captured is less then the amount of energy being exhausted by the vehicle 10. Therefore, the information display 66 may display the regenerative braking indicator 72 and the charge flow state indicator 70 as shown in FIG. 2d.

With reference back to step 130, if the regenerative braking system has not been activated, then the flow diagram 100 may proceed to step 210. In step 210, the controller 54 may determine if the battery 48 is in the positive or negative charge flow state. If the vehicle 10 is in the positive charge flow state, the flow diagram 100 may proceed to step 220 and the controller 54 may transmit the positive charge flow state such that the information display 66 may display the charge flow state indicator 70 as illustrated in FIG. 2a. Conversely, if the battery 48 is in the negative charge flow state, then the flow diagram may proceed to step 230. In step 230, the controller 54 may transmit the negative charge flow state such that the information display 66 may display the charge flow state indicator 70 as illustrated in FIG. 2b.

It should be noted that the method of FIG. 3 as described herein is exemplary only, and that the functions or steps of the methods could be undertaken other than in the order described and/or simultaneously as may be desired, permitted, and/or possible.

While the best mode for carrying out the application has been described in detail, those familiar with the art to which this application relates will recognize various alternative designs and embodiments for practicing the application as defined by the following claims.

What is claimed:

1. An information display system for a vehicle including an engine and an electric machine, each operable to provide torque to propel the vehicle, the vehicle further including an electric power source configured to provide electric power to the electric machine, the information display system comprising:
an information display configured to display a regenerative braking indicator; and
a controller being configured to receive regenerative braking information corresponding to a regenerative braking system, the controller further being configured to determine a regenerative braking state based upon the regenerative braking information, and the controller further being configured to transmit the regenerative braking state so that the information display displays the regenerative braking indicator that corresponds to the regenerative braking state.

2. The information display system of claim 1, wherein the controller is further configured to receive friction braking information corresponding to a friction braking system, the controller further being configured to determine a regenerative and friction braking state based upon the regenerative braking information and the friction braking information.

3. The information display system of claim 2, wherein the controller is further configured to transmit the regenerative and friction braking state so that the information display displays the regenerative braking indicator that corresponds to the regenerative and friction braking state.

4. The information display system of claim 1, wherein the information display is further configured to display a charge flow state indicator, and the controller further being configured to receive charge flow information corresponding to a charge flow of the electric power source.

5. The information display system of claim 4, wherein the controller is further configured to determine a negative charge flow state based upon the charge flow information, wherein the negative charge flow state corresponds to a state in which energy discharged by the electric power source exceeds energy captured by the electric power source.

6. The information display system of claim 5, wherein the controller is further configured to transmit the negative charge flow state so that the information display displays the charge flow state indicator that corresponds to the negative charge flow state.

7. The information display system of claim 4, wherein the controller is further configured to determine a positive charge flow state based upon the charge flow information, wherein the positive charge flow state corresponds to a state in which energy captured by the electric power source exceeds energy discharged by the electric power source.

8. The information display system of claim 7, wherein the controller is further configured to transmit the positive charge flow state so that the information display displays the charge flow state indicator that corresponds to the positive charge flow state.

9. The information display system of claim 1, wherein the information display is further configured to display a state of charge indicator, and the controller further being configured to receive state of charge information corresponding to a state of charge of the electric power source.

10. The information display system of claim 9, wherein the controller is further configured to determine a state of charge based upon the state of charge information, and the controller further being configured to transmit the state of charge so that the information display displays the state of charge indicator that corresponds to the state of charge.

11. A method for displaying a information about a vehicle using an information display system, the vehicle including an engine and an electric machine, each operable to provide torque to propel the vehicle, the vehicle further including an electric power source configured to provide electric power to the electric machine, the method comprising:
receiving regenerative braking information corresponding to a regenerative braking system;
determining a regenerative braking state based upon the regenerative braking information;
transmitting the regenerative braking state to an information display;
displaying a regenerative braking indicator that corresponds to the regenerative braking state.

12. The method of claim 11 further comprising receiving friction braking information corresponding to a friction braking system, and determining a regenerative and friction braking state based upon the regenerative braking information related and the friction braking information.

13. The method of claim 12 further comprising transmitting the friction and regenerative braking state to the information display, and displaying the regenerative braking indicator that corresponds to the regenerative and friction braking state.

14. The method of claim 11 further comprising receiving charge flow information corresponding to a charge flow of the electric power source.

15. The method of claim 14 further comprising determining a negative charge flow state based upon the charge flow information, wherein the negative charge flow state corresponds to a state in which energy discharged by the electric power source exceeds energy captured by the electric power source.

16. The method of claim 15 further comprising transmitting the negative charge flow state to the information display, and displaying a charge flow state indicator that corresponds to the negative charge flow state.

17. The method of claim 14 further comprising determining a positive charge flow state based upon the charge flow information, wherein the positive charge flow state corresponds to a state in which energy captured by the electric power source exceeds energy discharged by the electric power source.

18. The method of claim 17 further comprising transmitting the positive charge flow state to the information display, and displaying a charge flow state indicator that corresponds to the positive charge flow state.

19. The method of claim 11 further comprising:
receiving state of charge information corresponding to a state of charge of the electric power source;
determining the state of charge based upon the state of charge information;
transmitting the state of charge to the information display; and
displaying a state of charge indicator that corresponds to the state of charge.

20. An information display system for a vehicle including an engine and an electric machine, each operable to provide torque to propel the vehicle, the vehicle further including an electric power source configured to provide electric power to the electric machine, the information display system comprising:
an information display configured to display a regenerative braking indicator, a charge flow state indicator, and a state of charge indicator; and
a controller being configured to receive information related to a regenerative braking system and a friction braking system, the controller further being configured to determine a regenerative and friction braking state based upon the information related to the regenerative braking system and the friction braking system, and the controller further being configured to transmit the regenerative and friction braking state so that the information display displays the regenerative braking indicator that corresponds to the regenerative and friction braking state, the controller further being configured to receive charge flow information corresponding to a charge flow of the electric power source and display the charge flow indicator corresponding to a negative charge flow state or a positive charge flow state, the controller further being configured to receive state of charge information corresponding to a state of charge of the electric power source and display the state of charge indicator based upon the state of charge information.
